(19) United States
(12) Patent Application Publication
(10) Pub. No.: US 2014/0288824 A1
(43) Pub. Date: Sep. 25, 2014

(54) METHOD AND/OR SYSTEM FOR SELECTIVE APPLICATION OF DIRECTION OF TRAVEL

(71) Applicant: QUALCOMM Incorporated, San Diego, CA (US)

(72) Inventors: Tero H. Huttunen, Tampere (FI); Joseph Czompo, San Jose, CA (US)

(73) Assignee: QUALCOMM Incorporated, San Diego, CA (US)

(21) Appl. No.: 14/082,056

(22) Filed: Nov. 15, 2013

Related U.S. Application Data
(60) Provisional application No. 61/804,575, filed on Mar. 22, 2013.

(51) Int. Cl. G01C 21/16

(52) U.S. Cl. CPC G01C 21/165
USPC 701/472; 701/469

(57) ABSTRACT

Described are a system, method and apparatus for computing a navigation solution. In a particular implementation, a direction of travel (DOT) indicator or vector may be applied to augment computation of the navigation solution. The DOT indicator or vector may be selectively applied in the computation of the navigation solution based, at least in part, on an assessment of reliability of the DOT indicator or vector.

### CROSS-REFERENCE TO RELATED APPLICATIONS

This application claims the benefit of and priority to U.S. Provisional Patent Application Ser. No. 61/804,575, entitled “Method and/or System for Selective Application of Direction of Travel,” filed on Mar. 22, 2013, which is assigned to the assignee hereof and expressly incorporated herein by reference.

### BACKGROUND

1. Field

The subject matter disclosed herein relates to control of navigation functions on mobile devices.

2. Information

Global navigation satellite systems (GNSSs), such as the Global Positioning System (GPS), and other satellite positioning systems (SPSs), as well as terrestrial-based positioning systems, have enabled navigation capability on mobile devices and automobile navigation systems. For example, by processing SPS signals to obtain pseudorange measurements to measuring transmitters at known locations, a mobile device or automobile navigation system may estimate its location and obtain a “position fix” that may be utilized for navigation purposes. In addition to using acquired SPS signals, particular implementations of a mobile device or automobile navigation system may integrate measurements from multiple sources such as inertial sensors including accelerometers and gyroscopes. Other sources such as route maps, etc., may provide a “direction of travel” that may further assist in computation of a navigation solution.

### BRIEF DESCRIPTION OF DRAWINGS

Non-limiting and non-exhaustive aspects are described with reference to the following figures, wherein like reference numerals refer to like parts throughout the various figures.

FIG. 1 is a schematic diagram of a system for determining a navigation solution according to an embodiment.

FIG. 2 is a flow diagram of a process for selectively applying a direction of travel (DOT) vector or indicator in the computation of a navigation solution according to an embodiment.

FIG. 3 is a schematic diagram of a mobile device according to an embodiment.

### SUMMARY

Briefly, particular implementations are directed to a method comprising, at a computing device: obtaining a direction of travel (DoT) indicator or vector; and combining measurements to compute a navigation solution, wherein combining said measurements further comprises selectively applying said DoT indicator or vector in computing said navigation solution based, at least in part, on an assessment of reliability of said DoT indicator or vector.

Another particular implementation is directed to a mobile device comprising: a receiver to receive radio frequency signals; and a processor to: obtain a DoT indicator or vector; and combine measurements obtained from said received radio frequency signals to compute a navigation solution, wherein combining said measurements further comprises selectively applying said DOT indicator or vector in computing said navigation solution based, at least in part, on an assessment of reliability of said DOT indicator or vector.

Another particular implementation is directed to an apparatus for managing a navigation process on a mobile device, comprising: means for obtaining a DoT indicator or vector; and means for combining measurements to compute a navigation solution, wherein combining said measurements further comprises selectively applying said DoT indicator or vector in computing said navigation solution based, at least in part, on an assessment of reliability of said DoT indicator or vector.

Another particular implementation is directed to an article comprising: a non-transitory storage medium comprising machine-readable instructions stored thereon which are executable by a special purpose computing apparatus to: obtain a DoT indicator or vector; and combine measurements to compute a navigation solution, wherein combining said measurements further comprises selectively applying said DoT indicator or vector in computing said navigation solution based, at least in part, on an assessment of reliability of said DoT indicator or vector.

It should be understood that the aforementioned implementations are merely example implementations, and that claimed subject matter is not necessarily limited to any particular aspect of these example implementations.

### DETAILED DESCRIPTION

A navigation system that computes a position fix based on measurements or observations of signals transmitted by a global navigation satellite system (GNSS) typically processes such observations or measurements in a Kalman filter to update an estimate or prediction of a motion state defined, for example, by location, velocity and/or acceleration in a reference system. In a particular implementation, a direction of travel (DOT) obtained from an external source may be used as an input signal to a Kalman filter for generating a navigation solution such as a position fix. For example, a Kalman filter may combine a DOT indicator or vector with pseudorange and pseudorange rate measurements (e.g., from acquisition of signals transmitted by a GNSS and/or signal measurements obtained from on-suite inertial sensors such as accelerometers or gyroscopes) to update an estimated or predicted motion state. A DOT indicator or vector may be determined or obtained by any one of several different sources. In one implementation, a DOT indicator or vector may be provided to a position engine by an external source such as, for example, a pre-programmed navigation route. Here, an estimated location of a mobile device may be correlated with a position along a pre-programmed route. Of course this is just an example of how a DOT indicator vector may be determined and claimed subject matter is not limited in this respect. In particular implementations, a DoT indicator or vector may indicate an angular value relative to some reference angle (e.g., true North) to express a directional component of a velocity of a mobile device. For example, such a directional component may express a directional component of velocity of the mobile device in a plane (e.g., two-dimensional surface of an area covered by a map). It should be understood, however, that this is merely an example of a DoT indicator or vector, and claimed subject matter is not limited in this respect.

While a DOT indicator or vector may be useful in aiding GNSS and/or GNSS/sensor integrated positioning. A DOT indicator or vector, however, occasionally has limited reliability. An erroneous DOT indicator or vector may introduce erroneous inferences into a navigation solution. According to an embodiment, methods and processes may evaluate conditions to determine whether a received or incoming DOT indicator or vector is to be trusted, deweighted or discarded, for use in aiding the determination of a navigation solution (e.g., updating a Kalman filter state). This may increase an overall quality, accuracy and reliability of the GNSS or GNSS-sensor integrated positioning solution.

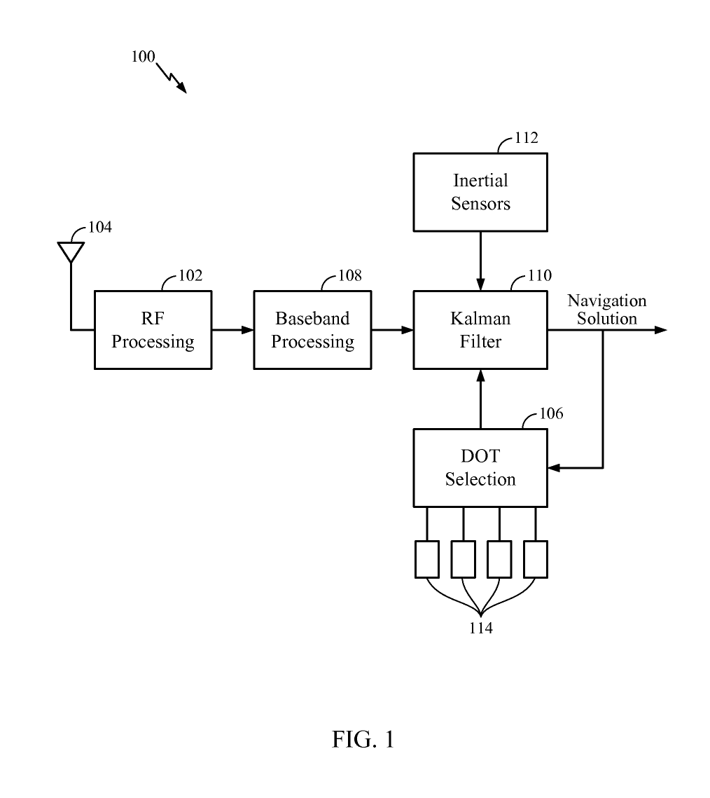

FIG. 1 is a schematic diagram of a system 100 for determining a navigation solution according to an embodiment. In particular implementations, system 100 may be integrated with a mobile device (e.g., a mobile communication device such as a cellular telephone) or an automobile navigation system. Of course these are merely examples of devices that may incorporate features described in connection with system 100 for the purpose of computing a navigation solution and claimed subject matter is not limited in this respect. A Kalman filter 110 may combine measurements from multiple sources in computing a navigation solution. In a particular implementation, such a navigation solution may comprise an estimate and/or prediction of a particular motion state of a mobile device defined, at least in part, by a location and/or velocity. In one implementation, a navigation solution may indicate a “heading” or direction of movement.

One source of measurements processed by Kalman filter 110 to compute a navigation solution may comprise pseudorange and/or pseudorange rate measurements derived from the acquisition of signals acquired at antenna 104 and radio frequency (RF) processing 102. Baseband processing 108 may perform operations to generate measurements of pseudorange and/or pseudorange rate based, at least in part, on signals transmitted by transmitters and acquired at RF processing 102. For example, such acquired signals may be transmitted from transmitters in a global navigation satellite system (GNSS), regional satellite system (RSS) or other satellite positioning system (SPS). Alternatively, such acquired signals may be transmitted from terrestrial transmitters such as cellular base station transmitters.

Kalman filter 112 may also process measurements obtained from inertial sensors 112 in computing a navigation solution. For example, measurements of signals received accelerometers, magnetometers, gyroscopes, etc. may be incorporated with other measurements such as pseudorange and pseudorange rate measurements to compute a navigation solution. As pointed out above, in addition to combining measurements obtained from inertial sensors 112 or pseudorange measurements obtained from baseband processing 108, Kalman filter 110 may incorporate a DOT indicator or vector. Such a DOT indicator or vector may be provided from any one of multiple DOT sources 114. In one particular implementation, a DOT source 114 may extract a DOT indicator or vector from a portion of a predetermined or pre-planned route at a current estimated location of system 100. For example, a trajectory of a predetermined or pre-planned route at a current estimated location may provide a reliable DOT indicator or vector. In another embodiment, a DOT source 114 may extract a DOT indicator or vector based, at least in part, on magnetometer-derived direction measurements, or independently available velocity measurements. It should be understood, however, that these are merely examples of how a DOT indicator or vector may be determined at a DOT source, and claimed subject matter is not limited in this respect.

As pointed out above, incorporation of an erroneous DOT vector or indicator at a Kalman filter in computing a navigation solution may distort such a resulting navigation solution. According to a particular embodiment, DOT selection 106 may selectively provide a DOT vector or indicator to Kalman filter 112 for use in computing a navigation solution based, at least in part, on an assessment of reliability of the indicator or vector. For example, a DOT vector or indicator may be deweighted or disregarded altogether if the DOT vector or indicator is deemed to be unreliable.

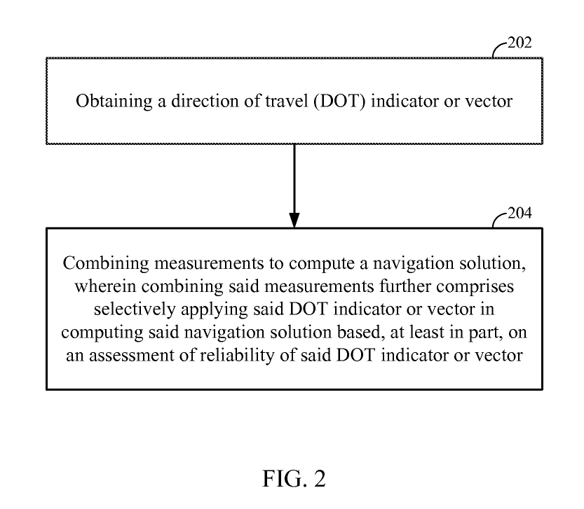

FIG. 2 is a flow diagram of a process for selectively applying a DOT vector or indicator in the computation of a navigation solution according to an embodiment. At block 202, a DOT indicator or vector is obtained. For example, DOT selection 106 may receive one or more DOT indicators or vectors from DOT sources 114 as described above. At block 204, measurements may be combined for computing a navigation solution such as, for example, an estimated and/or predicted location and/or velocity. As pointed out above, the combined measurements may comprise, for example, pseudorange or pseudorange rate measurements determined from acquisition of GNSS signals and/or measurements obtained from inertial sensors. Also, the DOT indicator or vector obtained at block 202 may be selectively applied in the computation of the navigation solution at block 204 based, at least in part, on an assessment of reliability of the DOT indicator or vector. Selective application of a DOT indicator or vector may comprise a decision to apply the DOT indicator or vector in computing a navigation solution or discarding the DOT indicator or vector altogether. Particular non-limiting examples of techniques for assessing reliability or a DOT indicator or vector are discussed below. It should be understood, however, that these are merely examples of how a reliability of a DOT indicator or vector may be evaluated for the purpose of selective application of the DOT indicator or vector in computing a navigation solution, and that claimed subject matter is not limited in this respect.

In particular implementations, an assessment of reliability of a DOT indicator or vector may comprise an indication that the DOT indicator or vector erroneous or highly suspected of being erroneous. For example, an erroneous DOT vector or indicator may be detected retroactively in a fault detection, identification and correction (FDIC) process. Here, a particular DOT indicator or vector may have been applied for aiding in determination of a navigation solution sometime in the past (e.g., a few seconds in the past) and may be subsequently evaluated based on current measurements, calculations or observations. Thus, measurements obtained following a previous DOT vector or identifier may be corroborate or refute the previous DOT indicator or vector. If a fault has been detected (e.g., DOT indicator or vector has been identified to be not applicable), the detected fault may be corrected retroactively by recomputing a current navigation state (e.g., estimated location and/or velocity) without applying the previously applied DOT indicator or vector. In one implementation, a history of Kalman filter states, GNSS pseudorange and range rate measurements, and sensor measurements in GNSS-sensor integrated navigation may be stored in a memory to enable recomputing a navigation solution without use of the DOT indicator or vector. If a recomputed Kalman filter state is substantially different or inconsistent with a current DOT vector or indicator, the current DOT indicator or vector may be considered to be erroneous, and therefore unreliable.

In another particular implementation, DOT selection 106 may determine and/or maintain an uncertainty metric in combination with a DOT vector or indicator to represent a degree of uncertainty in connection with a current DOT vector or indicator. Such an uncertainty metric may comprise, for example, an uncertainty angle. In a particular implementation, a measure of uncertainty of a DOT indicator or vector may be directly indicative of a reliability of the DOT indicator or vector for use in computing a navigation solution. Here, for example, an uncertainty metric may be numerically increased in response to detection of a turn by, for example, one or more signals received from a vertical gyroscope. In particular implementations, a DOT vector or indicator obtained at DOT selection 106 from a DOT source 114 may comprise a time-lagging indicator of a direction of travel. If a turn is in fact currently taking place while evaluating reliability of a current DOT indicator or vector at DOT selection 106, it is possible that any current change in direction was not taken into account in computing the current DoT indicator or vector. Therefore, the DOT indicator or vector for a vehicle may be presumed to have a larger error if inertial sensor measurements indicate that the vehicle is turning, for example. Here, an uncertainty of the DOT indicator or vector may be quantified based, at least in part, on a computed error. For example, an amount of increase in uncertainty of a DOT indicator or vector may be determined based, at least in part, on an angular velocity measured by a vertical gyroscope and integration of the measured angular velocity over an appropriate time interval (e.g., time reference applied to the DOT indicator or vector to a present time) to quantify a change in direction. In another example, an increase in uncertainty of a DoT may be determined based, at least in part, on a difference between a change in DoT and an angular change based on an integration of a vertical gyro signal. In another example implementation, an increase in uncertainty of a particular DOT vector or indicator from a detection of turning (e.g., from angular velocity measurements) may be sustained for a significant duration even after a turn in question has ended. Here, sustaining an increase in an uncertainty in a DOT vector or indicator may enable DOT sources (e.g., DOT sources 114) to adjust to a new direction of travel at the end of the turn. It should be understood, however, that these are merely examples of quantifying an increase in uncertainty of a DoT vector or indicator, and claimed subject matter is not limited in this respect.

A DOT indicator or vector may be just one indication of a heading. Other sources of a heading indication may include, for example, GNSS velocity based heading, GNSS-sensor integrated heading, camera-based heading, magnetometer-based heading, WiFi or other RF signal based heading, etc., or in general, any heading info that can be observed in a vehicle by any means. It should be understood, however, that these are merely examples of sources of a heading indication, and claimed subject matter is not limited in this respect. A particular implementation may specify a fault detection method in which a received DoT indicator or vector is compared against other heading sources as listed above, or any combination of heading sources. In a particular implementation, a reference heading may be selected for comparison with DOT vector or indicator. This selection may be performed using any one of several different techniques. For example, the reference heading may be selected from among multiple available heading indications if it has a lowest associated uncertainty. Alternatively, a combination of some or all heading indications may be computed to provide a heading reference. Alternatively, multiple reference headings may be selected, in which case the DoT may be compared against some or all reference headings.

If the received DOT indicator or vector differs from one or more reference headings by an amount that exceeds a specified threshold, the received DOT indicator or vector may be determined to be invalid (e.g., and not applied in computing a navigation solution at Kalman filter 112). In one implementation, a DoT indicator or vector may be determined to be invalid based, at least in part, on a received DoT indicator or vector and a reference heading. As pointed out above, such a reference heading may be selected from among any one of several candidate reference headings such as, for example, a reference heading computed solely from GNSS measurements and various sensor assisted headings obtained from one or more navigation engines, just to provide a few examples. In an example embodiment, a reference heading may be selected as the candidate reference heading having the lowest associated uncertainty. According to an embodiment, a DoT vector or indicator may be determined to be invalid if a computed value exceeds a threshold according to expression (1) as follows:

DoT invalid if(DoT−Wheading)²/Var(Wheading)>T, (1)

where:
DoT=DoT indicator or vector;
Ref=selected reference heading;
Wheading=(Var(DoT)*DoT+Var(Ref)*Ref)/(Var(DoT)+Var(Ref));
Var(Wheading)=1/(1/Var(DoT)+1/Var(Ref));

Here, expression (1) specifies a ratio (DoT−Wheading)²/Var(Wheading) to be compared with a rejection threshold T. In an alternative implementation, an uncertainty value (Unc), and its square (Var), may be a suitably selected error measure of certainty in connection with a DoT indicator or vector and reference heading. For example, expression (2) as follows contemplates a different ratio abs(DoT−Wheading)/Unc(Wheading) for comparison to the same or different rejection threshold T′ to accept or reject a DoT indicator or vector:

DoT valid if abs(DoT−Wheading)/Unc(Wheading)>T′, (2)

where:
Unc(Wheading) is the square root of variance Var(Wheading).

Determining validity or invalidity of a DoT indicator or vector (DoT) according to expressions (1) and (2) is demonstrated by four example cases below. In a first case, uncertainty of a DoT is high while an uncertainty regarding a reference heading is low. Here, a value for Wheading may approach a value for a selected reference heading (Ref). Also, Ref and Var(Wheading) may also be low. Accordingly, if DoT significantly differs from Ref, expression (1) may divide a relatively large quantity (DoT-Wheading)² by a relatively small quantity Var(Wheading). This may produce a large ratio in expression (1) that exceeds T, leading to a rejection of DoT as being invalid. If DoT is close to Ref, DoT may be acceptable since the ratio of expression (1) may be small enough, although its contribution may be small because its uncertainty is high. Here, it can be seen that if a reference heading is already of high quality (has low unc), a DoT indicator or vector with high uncertainty may not provide substantial improvement.

In a second case, uncertainty for both DoT and Ref may both be low. Here, a value for Wheading may be between DoT and Ref. In this case, it may be difficult to determine whether DoT or Ref is more accurate as both have low uncertainties. Assuming that both Dot and Ref would be measurements of the true heading, a combined heading may be selected as Wheading. As both DoT and Ref have low uncertainty, a resulting uncertainty for Wheading may also be low. While DoT may not be a measurement of the true heading, DoT may be tested against Wheading to evaluate the usefulness of DoT. If DoT is far enough away from Ref such that a ratio in expression (1) or (2) is high, DoT may be rejected because Ref may be more trusted in this situation. However, if DoT is very close to Ref, Ref may be confidently wrong by a small angle. In that case DoT, may not be rejected because the ratio computed ratio at expressions (1) and (2) are small. In effect, if Ref is close to the direction of the road (e.g., as expressed by DoT), the DoT input may be allowed to be processed in a Kalman filter for generating a navigation solution. In an third case, uncertainty in DoT and Ref may both be high. Here, a value for Wheading may be near DoT and Var(Wheading) may also be high. As both uncertainties are high, information available may not be indicative of a true heading. In this case an available DoT may be accepted as valid. Here, a ratio computed according to expressions (1) or (2) may be small enough even if DoT is significantly different from Ref (e.g., since Var(Wheading) is high).

In a fourth case, uncertainty for DoT may be low while an uncertainty for Ref may be high. Here, a value for Wheading may be near DoT while Var(Wheading) is low. As such, a current estimate for heading (Ref) may be erroneous and a current value for DoT may be used. As Wheading approaches DoT, the difference may be small. A small ratio computed according to expressions (1) and (2) may allow the DoT input to be accepted.

Another particular implementation may use starting and ending DOT indicators or vectors as an indicator of a nearby intersection or other area where an erroneous DOT vector or indicator can significantly distort a computed navigation solution. Here, an uncertainty in a DOT indicator or vector may be increased to avoid applying suspicious DOT vectors or indicators. As DOT indicators or vectors are received, an additional uncertainty may be applied for a duration of few seconds before and after the intersection. If receipt of DOT indicators or vectors ceases, uncertainty may be increased retroactively. However, in this implementation, an uncertainty may be increased even if no fault is detected. Such an increase in uncertainty may be reflected by or implemented in an increase in Var(DoT) as applied in expressions (1) or (2) above.

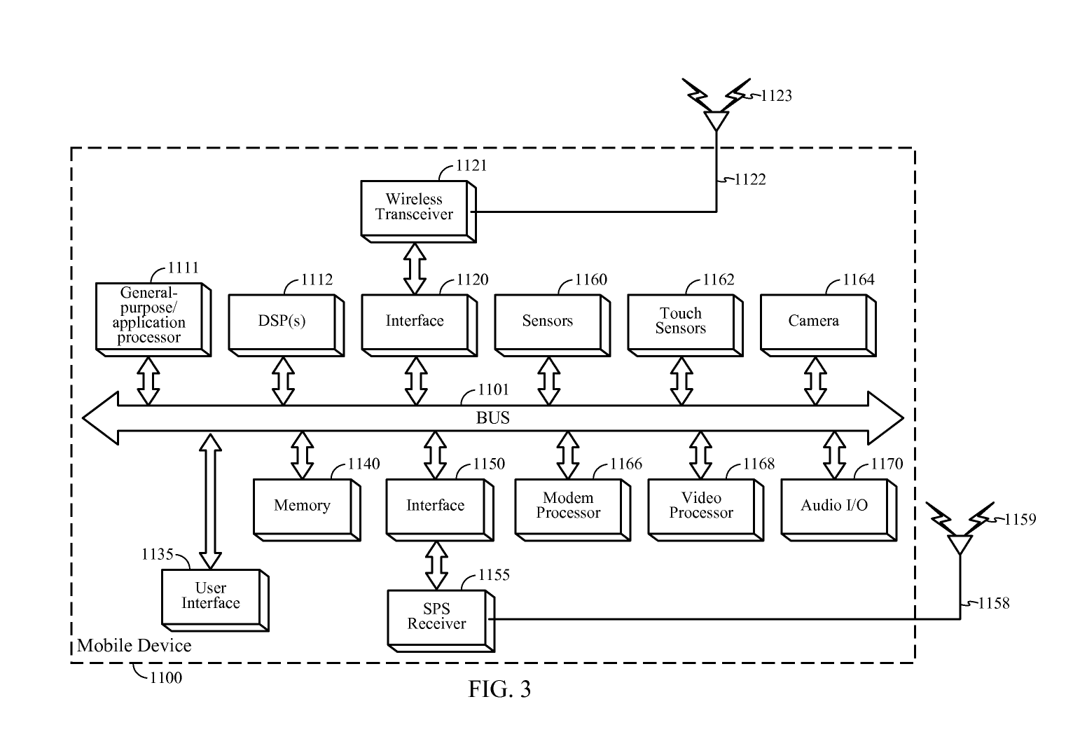

FIG. 3 is a schematic diagram of a mobile device according to an embodiment. System 100 (FIG. 1) may comprise one or more features of mobile device 1100 shown in FIG. 3. In particular implementations, aspects of mobile device 1100 may comprise a mobile telephone or may be integrated with an automobile navigation system, for example. In certain embodiments, mobile device 1100 may also comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth, just to name a few examples.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown).

Also shown in FIG. 3, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein.

Also shown in FIG. 3, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). As pointed out above, angular velocity as measured by a vertical gyroscope may be used to measure a change in heading that may affect an uncertainty or validity of a DOT indicator or vector. Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose application processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Such baseband processing may provide pseudorange and/or pseudorange rate measurements for use in computing a navigation solution (e.g., using a Kalman filter) as discussed above. Similarly, modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

In a particular implementation, mobile device 1000 may be capable of performing one or more of the actions set forth in the process of FIG. 2. For example, DPS(s) 1112 or general purpose application processor 1111 may perform all or a portion of actions at blocks 202 or 204. Here, DPS(s) 1112 or general purpose application processor 1111 may be used to implement a Kalman filter (e.g., Kalman filter 110) for combining measurements to provide a navigation solution. DPS(s) 1112 or general purpose application processor 1111 may also be used to implement logic for accepting or rejecting a DOT indicator or vector for selective application in the computation of a navigation solution as described above (e.g., DoT selection 106).

Techniques described herein may be used with an SPS that includes any one of several GNSS or combinations of GNSS. An SPS may include a system of transmitters positioned to enable entities to determine their location on or above the Earth based, at least in part, on signals received from the transmitters. Such a transmitter may transmit a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS. Furthermore, such techniques may be used with positioning systems that utilize terrestrial transmitters acting as “pseudolites”, or a combination of SVs and such terrestrial transmitters. The terms “SPS signals,” as used herein, is intended to include SPS-like signals from terrestrial transmitters, including terrestrial transmitters acting as pseudolites or equivalents of pseudolites.

Reference throughout this specification to “one example”, “an example”, “certain examples”, or “exemplary implementation” means that a particular feature, structure, or characteristic described in connection with the feature or the example may be included in at least one feature or example of claimed subject matter. Thus, the appearances of the phrase “in one example”, “an example”, “in certain examples” or “in certain embodiments” or other like phrases in various places throughout this specification are not necessarily all referring to the same feature, example, or limitation. Furthermore, the particular features, structures, or characteristics may be combined in one or more examples or features.

The methodologies described herein may be implemented by various measures depending upon applications according to particular features or examples. For example, such methodologies may be implemented in hardware, firmware, or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “transitioning,” “scheduling,” “activating,” “deactivating,” “accepting,” “conveying,” “deriving,” “updating,” “determining”, “establishing”, “obtaining”, or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method, at a mobile device, comprising:
obtaining a direction of travel (DOT) indicator or vector; and
combining measurements to compute a navigation solution, wherein combining said measurements further comprises selectively applying said DOT indicator or vector in computing said navigation solution based, at least in part, on an assessment of reliability of said DOT indicator or vector.

2. The method of claim 1, wherein said measurements are obtained, at least in part, by acquisition of at least one satellite positioning system (SPS) signal.

3. The method of claim 2, wherein said measurements further comprise measurements provided by one or more inertial sensors.

4. The method of claim 1, wherein said DOT indicator or vector is selectively applied based, at least in part, on a fault detection indication computed based, at least in part, on computation of a current navigation solution without use of past DOT indicators or vectors.

5. The method of claim 1, wherein said DOT indicator or vector is selectively applied based, at least in part, on a magnitude of an uncertainty metric, and further comprising increasing said magnitude in response to detection of a turn based on one or more gyroscope measurements.

6. The method of claim 1, and further comprising:
computing a weighted mean heading based, at least in part, on multiple heading indications;
dividing a difference between the weighted mean heading and the DOT indicator or vector by a measure of an uncertainty of the weighted mean heading; and
comparing said divided difference with a rejection threshold to determine whether said DOT indicator or vector is to be applied in computation of the navigation solution.

7. The method of claim 1, and further comprising:
increasing an uncertainty metric associated with the DOT indicator or vector in response to an indication of an approaching intersection; and
selectively applying said DOT indicator or vector in computing said navigation solution based, at least in part, on said increased uncertainty metric.

8. A mobile device comprising:
a receiver to receive radio frequency signals; and
a processor to:
obtain a direction of travel (DOT) indicator or vector; and
combine measurements obtained from said received radio frequency signals to compute a navigation solution, wherein combining said measurements further comprises selectively applying said DOT indicator or vector in computing said navigation solution based, at least in part, on an assessment of reliability of said DOT indicator or vector.

9. The mobile device of claim 8, wherein said measurements are obtained, at least in part, by acquisition of at least one satellite positioning system (SPS) signal.

10. The mobile device of claim 9, wherein said measurements further comprise measurements provided by one or more inertial sensors.

11. The mobile device of claim 8, wherein said DOT indicator or vector is selectively applied based, at least in part, on a fault detection indication computed based, at least in part, on computation of a current navigation solution without use of past DOT indicators or vectors.

12. The mobile device of claim 8, wherein said DOT indicator or vector is selectively applied based, at least in part, on a magnitude of an uncertainty metric, and further comprising increasing said magnitude in response to detection of a turn based on one or more gyroscope measurements.

13. The mobile device of claim 8, wherein said processor is further to:
compute a weighted mean heading based, at least in part, on multiple heading indications;
divide a difference between the weighted mean heading and the DOT indicator or vector by a measure of an uncertainty of the weighted mean heading; and
compare said divided difference with a rejection threshold to determine whether said DOT indicator or vector is to be applied in computation of the navigation solution.

14. The mobile device of claim 8, wherein said processor is further to:
increase an uncertainty metric associated with the DOT indicator or vector in response to an indication of an approaching intersection; and
selectively apply said DOT indicator or vector in computing said navigation solution based, at least in part, on said increased uncertainty metric.

15. An apparatus for managing a navigation process on a mobile device, comprising:
means for obtaining a direction of travel (DOT) indicator or vector; and
means for combining measurements to compute a navigation solution, wherein combining said measurements further comprises selectively applying said DOT indicator or vector in computing said navigation solution based, at least in part, on an assessment of reliability of said DOT indicator or vector.

16. The apparatus of claim 15, wherein said measurements are obtained, at least in part, by acquisition of at least one satellite positioning system (SPS) signal.

17. The apparatus of claim 16, wherein said measurements further comprise measurements provided by one or more inertial sensors.

18. The apparatus of claim 15, wherein said DOT indicator or vector is selectively applied based, at least in part, on a fault detection indication computed based, at least in part, on computation of a current navigation solution without use of past DOT indicators or vectors.

19. The apparatus of claim 15, wherein said DOT indicator or vector is selectively applied based, at least in part, on a magnitude of an uncertainty metric, and further comprising increasing said magnitude in response to detection of a turn based on one or more gyroscope measurements.

20. The apparatus of claim 15, and further comprising:
means for computing a weighted mean heading based, at least in part, on multiple heading indications;
means for dividing a difference between the weighted mean heading and the DOT indicator or vector by a measure of an uncertainty of the weighted mean heading; and
means for comparing said divided difference with a rejection threshold to determine whether said DOT indicator or vector is to be applied in computation of the navigation solution.

21. The apparatus of claim 15, and further comprising:
means for increasing an uncertainty metric associated with the DOT indicator or vector in response to an indication of an approaching intersection; and
means for selectively applying said DOT indicator or vector in computing said navigation solution based, at least in part, on said increased uncertainty metric.

22. An article comprising:
a non-transitory storage medium comprising machine-readable instructions stored thereon which are executable by a special purpose computing apparatus to:
obtain a direction of travel (DOT) indicator or vector; and
combine measurements to compute a navigation solution, wherein combining said measurements further comprises selectively applying said DOT indicator or vector in computing said navigation solution based, at least in part, on an assessment of reliability of said DOT indicator or vector.

23. The article of claim 22, wherein said measurements are obtained, at least in part, by acquisition of at least one satellite positioning system (SPS) signal.

24. The article of claim 23, wherein said measurements further comprise measurements provided by one or more inertial sensors.

25. The article of claim 22, wherein said DOT indicator or vector is selectively applied based, at least in part, on a fault detection indication computed based, at least in part, on computation of a current navigation solution without use of past DOT indicators or vectors.

26. The article of claim 22, wherein said DOT indicator or vector is selectively applied based, at least in part, on a magnitude of an uncertainty metric, and further comprising increasing said magnitude in response to detection of a turn based on one or more gyroscope measurements.

27. The article of claim 22, wherein said instructions are further executable by said special purpose computing apparatus to:
compute a weighted mean heading based, at least in part, on multiple heading indications;
divide a difference between the weighted mean heading and the DOT indicator or vector by a measure of an uncertainty of the weighted mean heading; and
compare said divided difference with a rejection threshold to determine whether said DOT indicator or vector is to be applied in computation of the navigation solution.

28. The article of claim 22, wherein said instructions are further executable by said special purpose computing apparatus to:
increase an uncertainty metric associated with the DOT indicator or vector in response to an indication of an approaching intersection; and
selectively apply said DOT indicator or vector in computing said navigation solution based, at least in part, on said increased uncertainty metric.
